(19) United States
(12) Patent Application Publication
(10) Pub. No.: US 2026/0008296 A1
(43) Pub. Date: Jan. 8, 2026

(54) DEVICE FOR TENSIONING A CANVAS ON A FRAME

(71) Applicant: GESPLAN GESTION CONSEIL INC., Québec (CA)

(72) Inventor: Francois Roy, Levis (CA)

(21) Appl. No.: 19/124,132

(22) PCT Filed: Oct. 23, 2023
(86) PCT No.: PCT/CA2023/051407

§ 371 Date: Apr. 24, 2025

Related U.S. Application Data
(60) Provisional application No. 63/419,011, filed on Oct. 25, 2022.

(51) Int. Cl. B44D 3/18

(52) U.S. Cl. CPC B44D 3/185

(57) ABSTRACT

A device for stretching a canvas mounted to at least a pair of side members includes a spacer having a central aperture therethrough and two opposing sides at an upper end that each terminate in a downwardly extending leg that is movable outwardly to engage an angled end surface of one of the side members. A screw engages the central aperture and has a threaded shaft that terminates at a screw head. At least one side wall is fixed with either the screw head or the spacer and is adapted for contacting the inside surface of each side member. In use, with the legs contacting the angled end surfaces, rotating the screw moves a spacer block to contact an inner surface of each leg to cause each leg to move outwardly to push the side members mutually away from each other to stretch the canvas.

### CROSS REFERENCE TO RELATED APPLICATIONS

This application claims the benefit of PCT Application PCT/CA 2023/051407, filed on Oct. 23, 2023, which claimed the benefit of US Provisional Patent Application 63/419,011, filed on Oct. 25, 2022, both incorporated herein by reference.

### STATEMENT REGARDING FEDERALLY SPONSORED RESEARCH AND DEVELOPMENT

Not Applicable.

### FIELD OF THE INVENTION

The present invention relates to the field of wooden frames for painter's canvas and printed canvas, and relates specifically to a device for tensioning a canvas on a frame comprising a plurality of side members mutually affixed at their angled ends.

### BACKGROUND

The solution for tensioning a canvas on a frame that is the easiest in term of tools consist in applying on a frame a piece of canvas of a larger size than the frame, then folding down the canvas along the four bars which forms the frame, while pulling on the canvas, for instance using a stretching plier, securing the canvas along the bars, for instance by stapling, while leaving free the canvas at the corner, and then, at each corner of the frame, folding back on itself the free part of the canvas so as to form folds which overlap, and then stapling the folds to the frame.

The above solution has the drawbacks that it requires the use of a stretching plier and that it is relatively time-consuming to implement if one wishes to correctly tension the canvas, since the user should tension it correctly all along the bars before securing it thereto. This must particularly be the case when the frames are of a larger size.

Furthermore, this solution supposes either that the user already has an assembled frame, or that the user assembles himself the four bars of the frame, which is an additional work which once again requires tools and is not easy for frames of larger sizes.

Some of the prior art solutions utilize rigid spacers that cooperate with a tensioner element that is fixed with the side members of the frame. The side members are pushed away from each other with a screw to effect canvas stretching. However, such prior solutions require excessive parts and as such are costly to manufacture. Prior art products also require insertion of a spacer from the outside frame members and cannot be inserted after frame and canvas assembly, resulting in additional processing costs in factories.

Therefore, there is a need for a device that has a minimum of parts, yet that can still effect stretching of the canvas by separation of the side members. Such a needed invention would be relatively inexpensive to manufacture and yet intuitive to use. The present invention accomplishes these objectives.

### SUMMARY OF THE INVENTION

The present device is a device for stretching a canvas mounted to at least a pair of side members, each mutually abutting at angled ends that each have at least an inside surface, and an angled end surface that has a groove open to each angled end surface. Such a device is used for stretching the canvas when mounted to, for example, four of the side members that form an artist's canvas frame.

The device, in its simplest first embodiment, includes a spacer having a central aperture therethrough that defines a longitudinal axis of the spacer. The spacer has two adjacent, opposing sides at an upper end of the spacer, each terminating in a leg extending downwardly and generally parallel to the longitudinal axis of the spacer. Each leg has an outer surface and an inner surface and is movable outwardly to engage the angled end surface of one of the side members when the spacer is positioned between two of the abutting side members at the angled end surfaces thereof.

A screw has a threaded shaft adapted for rotational engagement with the central aperture of the spacer. The threaded shaft terminates at a first end thereof with a screw head having an end surface that includes a tool-engaging recess, such as for a Philips screwdriver, Allen wrench, or the like.

At least one side wall is fixed with either the screw or the spacer and is adapted for contacting the inside surface of each side member. The at least one side wall is preferably a frustoconical side wall of the screw head. Alternately, the at least one side wall is formed in the upper end of the spacer and includes an angled surface adapted to contact the inside surface of each side member. Alternately still, the at least one side wall is incorporated into a frustoconical washer engaged with the screw. Any of these solutions serve to press the at least one side wall into the inside surfaces of each side member while the legs force the angled end surfaces of each side member mutually apart.

The inner surface of each leg of the spacer includes the inwardly-projecting ridge and further includes a spacer block having a central aperture therethrough threaded onto the threaded shaft of the screw. The spacer block is initially positioned away from the ridges so that the legs are in the retracted configuration, but upon rotating the screw the spacer block moves between the inwardly-projecting ridges of the legs to push each leg outwardly. The spacer block may initially be positioned close to the upper end of the spacer, or the spacer block may initially be positioned away from the upper end of the spacer. In some embodiments, the spacer block is temporarily connected to one or more of the legs with one or more connectors that, when the screw is rotated, break away from the spacer block as it moves upwardly or downwardly. Such connectors are relatively thin and frangible and may be integrally formed with the spacer and the spacer block via plastic injection molding, or the like.

In use, with the spacer fixed between the abutting side members with the outer surface of each leg contacting the angled end surface of one of the side members, and with the screw threaded through the central aperture of the spacer and spacer block, and the side wall contacting the inside surface of each side member, rotating the screw to move the spacer block to contact the ridge of the inner surface of each leg causes each leg to move outwardly such that the outer surface of each leg contacts the angled end surface of one of the side members to push the side members mutually away from each other along their respective longitudinal axes to stretch the canvas.

In some embodiments, the inner surface of one of the legs of the spacer includes an inwardly-projecting ridge adapted to contact the threaded shaft of the screw when the screw is fully engaged with the spacer. The threaded shaft of the screw when contacting the ridge pushing the leg outwardly. Preferably, however, the inner surface of both legs of the spacer includes the inwardly-projecting ridge.

In some embodiments having larger frames, a cross brace may be included across a central area of one or more of the side members. Each end includes a cross brace angled surface, and at least one of the side members includes a cross brace extension groove. A cross brace spacer and a cross brace screw that includes a cross brace screw head are positioned between each end of the cross brace and the corresponding side member. The cross brace spacer includes an angled distal edge adapted for engaging the cross brace angled surface, and a flat proximal edge adapted for engaging the cross brace extension groove of the side member. As such, with the cross brace spacer engaged with both the cross brace extension groove and the cross brace angled surface, rotating the cross brace screw to move the cross brace screw head closer to the cross brace spacer causes the cross brace spacer to move laterally outwardly away from the cross brace to expand the cross brace to stretch the canvas.

The present invention is a device that has a minimum of parts, namely two or three, and yet can affect sufficient stretching of the canvas by separation of the side members. The present invention is relatively inexpensive to manufacture and yet is also intuitive to use. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1A is a front elevational view of a third embodiment of the invention, illustrated in the retracted configuration;

FIG. 1B is a front elevational view of the embodiment of FIG. 1A, but illustrated in the expanded configuration;

FIG. 2A is a front elevational view of a fourth embodiment of the invention, illustrated in the retracted configuration;

FIG. 2B is a front elevational view of the embodiment of FIG. 2A, but illustrated in the expanded configuration;

FIG. 3A is a front elevational view of a fifth embodiment of the invention, illustrated in the retracted configuration;

FIG. 3B is a front elevational view of the embodiment of FIG. 3A, but illustrated in the expanded configuration;

FIG. 4A is a front elevational view of a cross brace spacer of the invention;

FIG. 4B is a perspective view of the cross brace spacer illustrated in use with a cross brace and a side member;

FIG. 4C is a cross-sectional view of an alternate embodiment of the cross brace spacer in a retracted configuration;

FIG. 4D is a cross-sectional view of the embodiment of FIG. 4A but in the expanded configuration;

FIG. 5A is a cross-sectional view of the invention, taken along longitudinal axes of two of the side members, illustrated in the retracted configuration between two abutting side members;

FIG. 5B is a cross-sectional view of the invention, taken along longitudinal axes of two of the side members, illustrated in the expanded configuration causing the two abutting side members to separate to stretch a canvas; and

FIG. 6 is an enlarged perspective view of FIG. 5A.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements but can also mean a singular element.

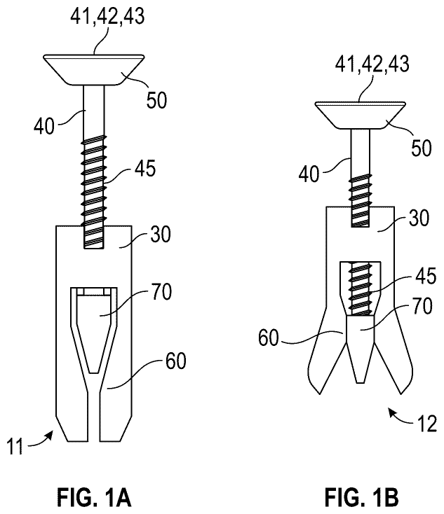

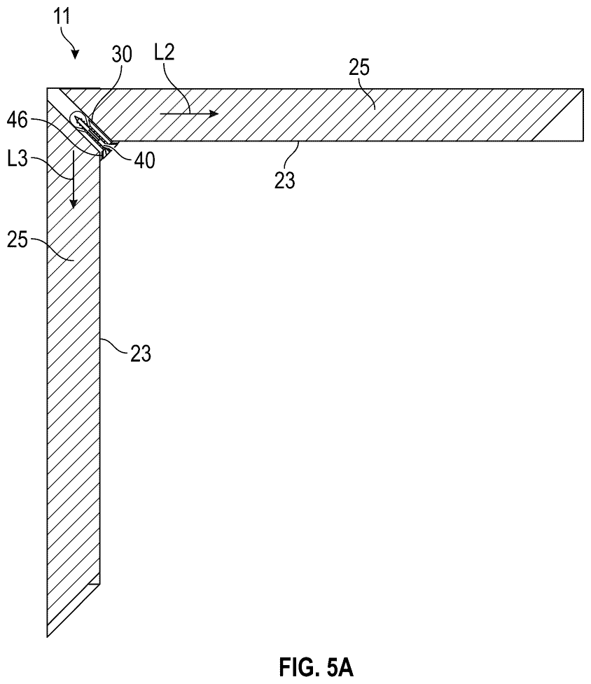

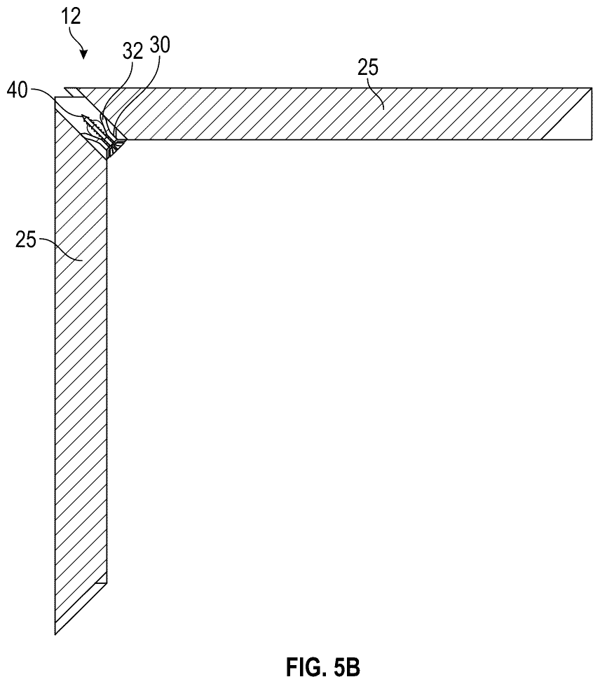

FIGS. 1A, 1B, 5A and 5B illustrate a device 10 for stretching a canvas 20 mounted to at least a pair of side members 25, each mutually abutting at angled ends 24 that each have at least an inside surface 23, and an angled end surface 22 that has a groove 21 open to each angled end surface 23. Such a device 10 is used for stretching the canvas 20 when mounted to, for example, four of the side members 25 that form an artist's canvas frame.

The device 10, in its simplest first embodiment, illustrated in FIGS. 1A and 1B, includes a spacer 30 having a central aperture 35 therethrough that defines a longitudinal axis L₁ of the spacer 30. The spacer 30 has two adjacent, opposing sides 36 at an upper end 38 of the spacer 30, each terminating in a leg 32 extending downwardly and generally 7 parallel to the longitudinal axis L₁ of the spacer 30. Each leg 32 has an outer surface 33 and an inner surface 31, and is movable outwardly to engage the angled end surface 22 9 (FIGS. 5A, 5B, and 7) of one of the side members 25 when the spacer 30 is positioned between two of the abutting side members 25 at the angled end surfaces 22 thereof. The inner surface 31 of the legs 32 of the spacer 30 include an inwardly-projecting ridge 60 (FIGS. 1A-1B) adapted to contact the threaded shaft 45 of a screw 40 when the screw 40 is fully engaged with the spacer 30. A threaded shaft 45 of the screw 40 when contacting a ridge 60 pushing the leg 32 outwardly.

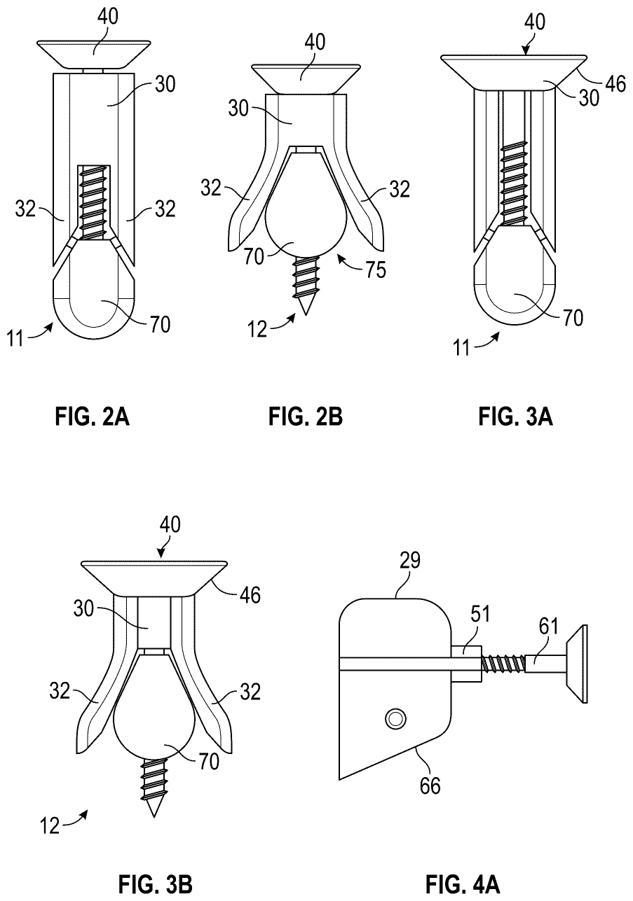

The inner surface 31 of each leg 32 of the spacer 30 includes the inwardly-projecting ridge 60 and further includes a spacer block 70 (FIGS. 1A-3B) having a central aperture 75 therethrough threaded onto the threaded shaft 45 of the screw 40. The spacer block 70 is initially positioned away from the ridges 60 so that the legs 32 are in a retracted configuration 11, but upon rotating the screw 40 the spacer block 70 moves between the inwardly-projecting ridges 60 of the legs 32 to push each leg 32 outwardly (FIGS. 1B, 2B, and 3B) in an expanded configuration 12. The spacer block 70 may initially be positioned close to the upper end 38 of the spacer 30 (FIG. 1A), or the spacer block 70 may initially be positioned away from the upper end 38 of the spacer 30 (FIG. 2A) and pulled upwardly by rotation of a screw 40. Preferably the spacer block 70 is keyed to the legs 32 of the spacer 30 such that rotating the screw 40 inhibits rotation of the spacer block 70.

The threaded shaft 45 is adapted for rotational engagement with the central aperture 35 of the spacer 30. The threaded shaft 45 terminates at a first end 41 thereof with a screw head 42 having an end surface 43 that includes a tool-engaging recess 44, such as for a Philips screwdriver, or the like. The screw 40 may be sold with the spacer 30 and the spacer block 70 or sold separately. 11

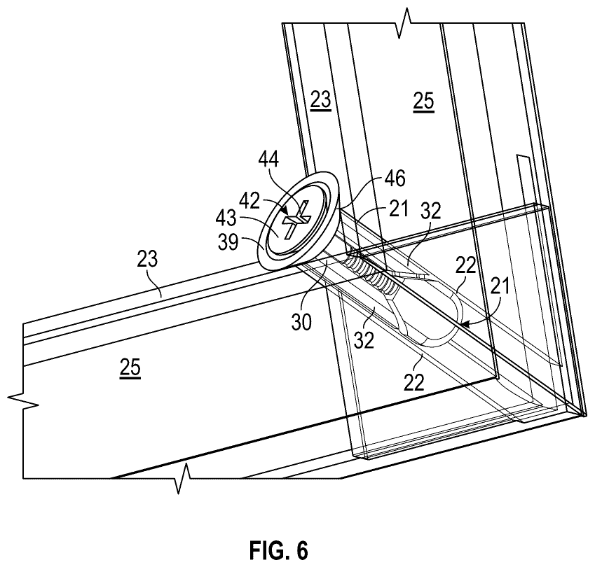

At least one side wall 50 is fixed with either the screw 40 or the spacer 30 and is adapted for contacting the inside surface 23 of each side member 25. The at least one side wall 50 is preferably a frustoconical side wall 46 of the screw head 42 (FIG. 1B). Alternately, the at least one side wall 50 is formed in the upper end 38 of the spacer 30 and includes an angled surface 37 (FIG. 3A) adapted to contact the inside surface 23 of each side member 25. Alternately still, the at least one side wall 50 is incorporated into a frustoconical washer 39 engaged with the screw 40 (FIG. 6).

In use, with the spacer 30 fixed between the abutting side members 25 with the outer surface 33 of each leg 32 contacting the angled end surface 22 of one of the side members 25, and with the screw 40 threaded through the central aperture 35 of the spacer 30 and the at least one side wall 50 contacting the inside surface 23 of each side member 25, rotating the screw 40 to move the screw 40 closer to the spacer 30 and to move the threaded shaft 45 to contact the inner surface 31 of each leg 32 causes each leg 32 to move outwardly such that the outer surface 33 of each leg 32 contacts the angled end surface 22 of one of the side members 25 to push the side members 25 mutually away from each other along their respective longitudinal axes L2, L3 to stretch the canvas 20.

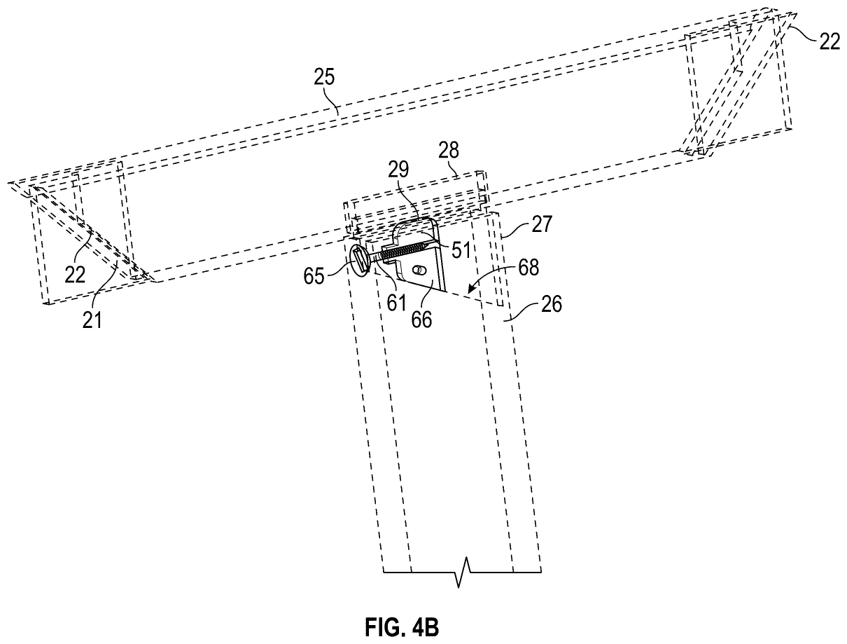

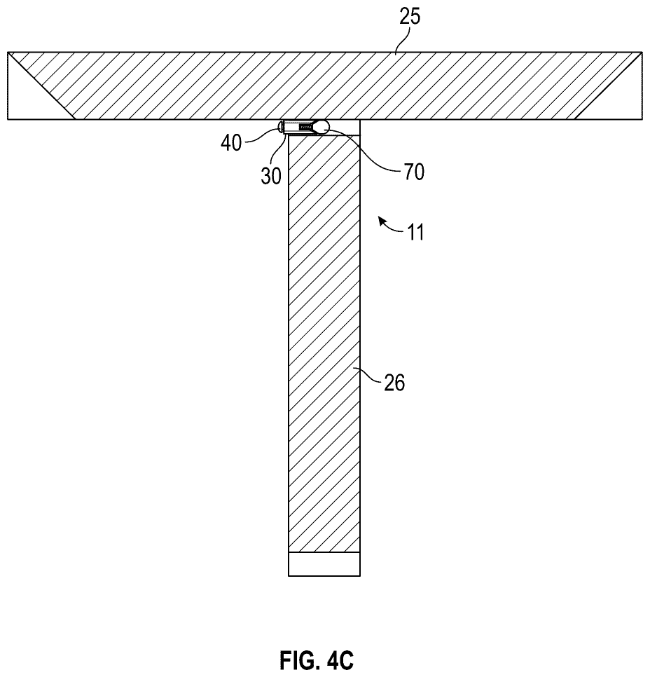

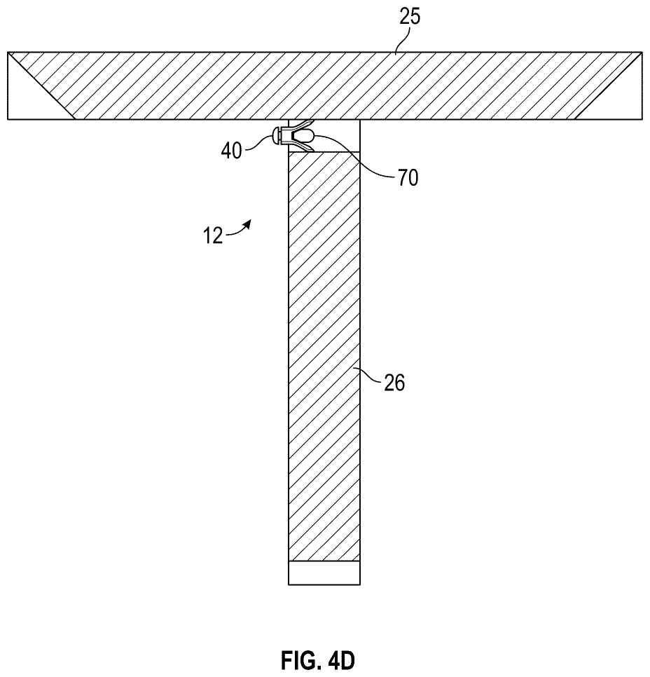

In some embodiments, the spacer block 70 is temporarily connected to one or more of the legs 32 with one or more connectors 72 (FIGS. 3A and 4A) that, when the screw 40 is rotated, break away from the spacer block 70 as the spacer block 70 moves upwardly or downwardly. Such connectors 72 are relatively thin and frangible and may be integrally formed with the spacer 30 and the spacer block 70 via a plastic injection molding process, or the like.

In some embodiments having larger frames, a cross brace 26 may be included across a central area of one or more of the side members 25 (FIGS. 5A-5D). Each end 27 includes a cross brace angled surface 68, and at least one of the side members 25 includes a cross brace extension groove 28. A cross brace spacer 51 and a cross brace screw 61 that includes a cross brace screw head 65 are positioned between each end 27 of the cross brace 26 and the corresponding side member 25. The cross brace spacer 51 includes an angled distal edge 66 adapted for engaging the cross brace angled surface 68, and a flat proximal edge 29 adapted for engaging the cross brace extension groove 28 of the side member 25. As such, with the cross brace spacer 51 engaged with both the cross brace extension groove 28 and the cross brace angled surface 68, rotating the cross brace screw 61 to move the cross brace screw head 65 closer to the cross brace spacer 51 causes the angled distal edge 66 to push against the cross brace angled surface 68, causing the cross brace 26 to laterally expand the cross brace 26 to stretch the canvas 20.

While a particular form of the invention has been illustrated and described, it will be apparent that various modifications can be made without departing from the spirit and scope of the invention. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A device for stretching a canvas mounted to a pair of side members each mutually abutting at angled ends that each have at least an inside surface, and an angled end surface having a groove open to each angled end surface, using a screw having a threaded shaft terminating at a first end thereof with a screw head having an end surface having a tool-engaging recess, the device comprising:
a spacer having a central aperture therethrough defining a longitudinal axis of the spacer, and two adjacent, opposing sides at an upper end of the spacer each terminating in a leg extending downwardly and parallel to the longitudinal axis of the spacer, each leg having an outer surface and an inner surface and movable outwardly to engage the angled end surface of one of the side members when the spacer is positioned between two of the abutting side members at the angled end surfaces thereof; and
at least one side wall fixed with the spacer and adapted for contacting the inside surface of each side member;
wherein the inner surface of each leg of the spacer includes an inwardly-projecting ridge, and further includes a spacer block having a central aperture therethrough threaded onto the threaded shaft of the screw, the spacer block positioned away from the inwardly-projecting ridges of each leg;
whereby with the spacer fixed between the abutting side members with the outer surface of each leg contacting the angled end surface of each side member, and with the screw threaded through the central aperture of the spacer and the spacer block, and the side wall contacting the inside surface of each side member, rotating the screw to move the spacer block to contact the ridge of the inner surface of each leg causes each leg to move outwardly such that the outer surface of each leg contacts the angled end surface of one of the side members to push the side members mutually away from each other along their respective longitudinal axes to stretch the canvas.

2. A device for stretching a canvas mounted to a pair of side members each mutually abutting at angled ends that each have at least an inside surface, and an angled end surface having a groove open to each angled end surface, the device comprising:
a spacer having a central aperture therethrough defining a longitudinal axis of the spacer, and two adjacent, opposing sides at an upper end of the spacer each terminating in a leg extending downwardly and parallel to the longitudinal axis of the spacer, each leg having an outer surface and an inner surface and movable outwardly to engage the angled end surface of one of the side members when the spacer is positioned between two of the abutting side members at the angled end surfaces thereof;
a screw having a threaded shaft adapted for rotational engagement with the central aperture of the spacer, the threaded shaft terminating at a first end thereof with a screw head having an end surface having a tool-engaging recess; and
at least one side wall fixed with either the screw or the spacer and adapted for contacting the inside surface of each side member;
wherein the inner surface of each leg of the spacer includes an inwardly-projecting ridge, and further includes a spacer block having a central aperture therethrough threaded onto the threaded shaft of the screw, the spacer block positioned away from the inwardly-projecting ridges of each leg;
whereby with the spacer fixed between the abutting side members with the outer surface of each leg contacting the angled end surface of each side member, and with the screw threaded through the central aperture of the spacer and the spacer block, and the side wall contacting the inside surface of each side member, rotating the screw to move the spacer block to contact the ridge of the inner surface of each leg causes each leg to move outwardly such that the outer surface of each leg contacts the angled end surface of one of the side members to push the side members mutually away from each other along their respective longitudinal axes to stretch the canvas.

3. The device of claim 2 wherein the inner surface of each leg of the spacer includes an inwardly-projecting ridge adapted to contact the threaded shaft of the screw when the screw is fully engaged with the spacer, the threaded shaft of the screw when contacting each ridge pushing each leg outwardly.

4. The device of claim 2 wherein the inner surface of each leg of the spacer includes an inwardly-projecting ridge, and further including a spacer block having a central aperture therethrough threaded onto the threaded shaft of the screw, the spacer block positioned away from the inwardly-projecting ridges of each leg, whereby rotating the screw causes the spacer block to move between the inwardly-projecting ridges of the legs to push each leg outwardly.

5. The device of claim 4 wherein the spacer block is initially positioned adjacent the spacer, whereby when the screw is rotated the spacer block is pushed downwardly to engage the inwardly-projecting ridges of the legs.

6. The device of claim 4 wherein the spacer block is initially positioned away from the spacer, whereby when the screw is rotated the spacer block is pulled upwardly to engage the inwardly-projecting ridges of the legs.

7. The device of claim 2 wherein the at least one side wall is a frustoconical side wall of the screw head adapted to contact the inside surface of each side member.

8. The device of claim 2 wherein the at least one side wall is incorporated into a frustoconical washer engaged with the screw.

9. The device of claim 4 wherein the spacer block is connected to one or more of the legs with one or more connectors that, when the screw is rotated, break away from the spacer block as the spacer block moves upwardly or downwardly, whereby the spacer block, connectors, and spacer can be integrally formed through an injection molding process.

10. The device of claim 2 further including a cross brace having two opposing ends, each end with a cross brace angled surface, at least one of the side members including a cross brace extension groove, and further including a cross brace spacer and a cross brace screw having a cross brace screw head, the spacer including an angled distal edge adapted for engaging the cross brace angled surface, and a flat proximal edge adapted for engaging the cross brace extension groove of the at least one side member, whereby with the cross brace spacer engaged with both the cross brace extension groove and the cross brace angled surface, rotating the screw to move the screw head closer to the cross brace spacer causes the cross brace spacer to laterally outwardly away from the cross brace to expand the cross brace to stretch the canvas.

11. A device for stretching a canvas mounted to a pair of side members each mutually abutting at angled ends that each have at least an inside surface, and an angled end surface having a groove open to each angled end surface, the device comprising:
a spacer having a central aperture therethrough defining a longitudinal axis of the spacer, and two adjacent, opposing sides at an upper end of the spacer each terminating in a leg extending downwardly and parallel to the longitudinal axis of the spacer, each leg having an outer surface and an inner surface and movable outwardly to engage the angled end surface of one of the side members when the spacer is positioned between two of the abutting side members at the angled end surfaces thereof;
a screw having a threaded shaft adapted for rotational engagement with the central aperture of the spacer, the threaded shaft terminating at a first end thereof with a screw head having an end surface having a tool-engaging recess; and
at least one side wall fixed with either the screw or the spacer and adapted for contacting the inside surface of each side member;
a cross brace having two opposing ends, each end with a cross brace angled surface, at least one of the side members including a cross brace extension groove, and further including a cross brace spacer and a cross brace screw having a cross brace screw head, the spacer including an angled distal edge adapted for engaging the cross brace angled surface, and a flat proximal edge adapted for engaging the cross brace extension groove of the at least one side member;
wherein the inner surface of each leg of the spacer includes an inwardly-projecting ridge, and further including a spacer block having a central aperture therethrough threaded onto the threaded shaft of the screw, the spacer block positioned away from the inwardly-projecting ridges of each leg; and
wherein the at least one side wall is a frustoconical side wall of the screw head adapted to contact the inside surface of each side member;
whereby with the spacer fixed between the abutting side members with the outer surface of each leg contacting the angled end surface of each side member, and with the screw threaded through the central aperture of the spacer and the spacer block, and the side wall contacting the inside surface of each side member, rotating the screw to move the spacer block to contact the ridge of the inner surface of each leg causes each leg to move outwardly such that the outer surface of each leg contacts the angled end surface of one of the side members to push the side members mutually away from each other along their respective longitudinal axes to stretch the canvas; and
whereby with the cross brace spacer engaged with both the cross brace extension groove and the cross brace angled surface, rotating the screw to move the screw head closer to the cross brace spacer causes the cross brace spacer to laterally outwardly away from the cross brace to expand the cross brace to stretch the canvas.
